(19) United States
(12) Patent Application Publication
(10) Pub. No.: US 2014/0196143 A1
(43) Pub. Date: Jul. 10, 2014

(54) METHOD AND APPARATUS FOR REAL-TIME VERIFICATION OF LIVE PERSON PRESENCE ON A NETWORK

(71) Applicant: IDENTITY VALIDATION PRODUCTS, LLC, DAINGERFIELD, TX (US)

(72) Inventors: SANDY FLIDERMAN, ALBERTSON, NY (US); CLAUDIO R. BALLARD, FORT LAUDERDALE, FL (US)

(21) Appl. No.: 14/010,085

(22) Filed: Aug. 26, 2013

Related U.S. Application Data
(60) Provisional application No. 61/694,742, filed on Aug. 29, 2012.

(51) Int. Cl. G06F 21/32

(52) U.S. Cl. CPC G06F 21/32
USPC 726/19

(57) ABSTRACT

A method for real-time verification of live person presence at a network location comprises the following steps: receiving a verification request at a network location; generating a real-time security indicia; displaying the real-time security indicia on a display screen at the network location; capturing with a back-facing camera at the network location, a real-time image of the field of view (FOV) in front of the display screen displaying the security indicia; detecting a human face in the FOV image; detecting an eye region of the human face in the FOV image; and detecting a reflected image of the security indicia in the eye region in the FOV image. If the reflected image of the security indicia is not detected in the eye region of the FOV image, the verification attempt is deemed unsuccessful, whereas if the reflected image of the security indicia is detected, the verification attempt is deemed successful.

### CROSS-REFERENCE TO RELATED APPLICATIONS

This application claims benefit of U.S. Provisional Application No. 61/694,742, filed Aug. 29, 2012, entitled METHOD AND APPARATUS FOR REAL-TIME VERIFICATION OF LIVE PERSON PRESENCE ON A NETWORK (Atty. Dkt. No. VMVM-31432), the specification of which is incorporated herein by reference in its entirety.

### TECHNICAL FIELD

The following disclosure relates to security methods and systems that may be implemented on computers and/or mobile devices connected to a network. More specifically, it relates to methods and systems for real-time verification that a live person is present at a network location using a display screen and a back-facing camera at the network location, and optionally, for verifying the identity of the live person.

### BACKGROUND

One issue of constant concern on computer networks is the control of access to user accounts. Accordingly, many security systems have been developed to protect network accounts against access by unauthorized automated software applications, e.g., web robots (also known simply as “bots”), and/or by unauthorized humans.

For example, bots can be used to defeat network security systems such as simple account log-on screens by systematically “guessing” user IDs and/or passwords until access is granted. It is known to employ various types of hardware and/or software security systems to combat such malicious bots. The most widely used anti-bot technique is the use of CAPTCHA, which is designed to distinguish between a human user and a less-sophisticated bot by means of a character recognition task that, ideally, only humans can perform successfully. However, many human users find CAPTCHA systems to be slow, confusing or annoying to use. This is especially true when the user needs to access the same account numerous times per day, or when a number of different accounts are accessed. A need therefore exists, for an improved system for verifying that a live person is at a network location.

It is known to use biometric security measures, e.g., facial recognition systems, iris-scan systems and retina-scan systems, to determine the identity of persons seeking access to user accounts. However, some facial recognition systems be defeated by presenting a photo or image of the authorized user's face to the biometric sensor of the system. Similarly, iris- and retina-scan systems may be defeated by presenting photos or images of the user's iris or retina. A need therefore exists, for an improved system to verify that the biometric data is coming from a live person at a network location.

### SUMMARY

In one aspect of the invention, there is provided real-time biometric authentication and “Live Person” validation for single sign-on and/or remote access via Internet, WAN, LAN, VPN or mobile network. This embodiment utilizes facial recognition (photo and or video capture from a stationary or mobile camera) with or without iris scan, and generates a number and or character or graphical rendering (barcode, 3d barcode, etc.) sequence/image that is displayed on a monitor, computer screen or handheld tablet or phone for the purposes of reading such a display as it is reflected real-time off the eye of the device user as part of a login verification sequence.

In another embodiment, there are provided two separate CAPTCHA codes displayed backwards on a PC monitor or smartphone that can be captured via eye reflection by a camera either in a video capture sequence or two synchronized photo captures that are randomly generated and displayed. Anything that an individual looks at is reflected off one's eyes, so with the right light, optics and extraction algorithms, such randomly generated sequences could be captured to effectively prove a real user is present for the purpose of facial recognition, and that the capture is being done real time, thereby mitigating any possibility of synthesizing such to defeat facial or iris recognition methods or techniques.

In another aspect of the invention, a method for real-time verification of live person presence at a network location comprises the following steps: receiving a verification request at a network location; generating a real-time security indicia; displaying the real-time security indicia on a display screen at the network location; capturing with a back-facing camera at the network location, a real-time image of the field of view (FOV) in front of the display screen displaying the security indicia; detecting a human face in the FOV image; detecting an eye region of the human face in the FOV image; and detecting a reflected image of the security indicia in the eye region in the FOV image. If the reflected image of the security indicia is not detected in the eye region of the FOV image, the verification attempt is deemed unsuccessful, whereas if the reflected image of the security indicia is detected, the verification attempt is deemed successful.

In yet another aspect, a method for execution on a mobile device for real-time verification of live person presence at a network location is provided, where the mobile device has a processor, a display screen operatively coupled to the processor, a memory operatively coupled to the processor, a communication device operatively coupled to the processor and a back-facing digital camera operatively coupled to the processor and having a field of view (“FOV”) such that the camera can photograph a face of a human user when the human user is viewing the display screen. The method comprises: producing, using the processor of a mobile device at a network location, a real-time security indicia on the mobile device; displaying, on a display screen of the mobile device that is operatively connected to the processor, the real-time security indicia at a known time at the network location; capturing, using a back-facing digital camera that is operatively connected to the processor and has a FOV such that the camera can photograph a face of a human user when the human user is viewing the display screen, an FOV image of the objects within the FOV in front of the display screen at the known time; and storing the FOV image in a memory of the mobile device that is operatively connected to the processor. The method further comprises: detecting, using the processor, any human face present in the FOV image stored in the memory; detecting, using the processor, an eye region of the human face present in the FOV image stored in the memory; and detecting, using the processor, whether a reflected image of the security indicia is present in the eye region of the human face in the FOV image stored in the memory. The result of the live person verification is determined to be “successful” if a reflected image of the real-time security indicia is detected in the eye region of the human face in the FOV image stored in the memory, while the result of the live person verification is determined to be “unsuccessful” if a reflected image of the security indicia is not detected in the eye region of the human face in the FOV image stored in the memory. The determined result of the live person verification is stored in the memory of the mobile device.

In another embodiment, the method further comprises the steps: performing a facial recognition operation on the human face detected in the FOV image from the memory to obtain a local facial recognition result; comparing the local facial recognition result with a facial recognition results for an authorized user; determining a facial recognition comparison result to be “successful” if the local facial recognition result is within a predetermined criteria to the facial recognition results for the authorized user; determining the facial recognition comparison result to be “unsuccessful” if the local facial recognition result is not within the predetermined criteria to the facial recognition comparison results for the authorized user; and recording the facial recognition comparison result in the memory

In yet another embodiment, the facial recognition operation includes: creating a local key corresponding to the local facial recognition results using the processor, the key including characteristics indicative of the facial recognition results, but not including an image of the human face from the FOV image; transmitting the local key to another network location using the communication device; comparing the local key to a user key corresponding to the facial recognition results for the authorized user at another network location; and receiving a facial recognition comparison result from another network location using the communication device.

In still another embodiment, the facial recognition operation includes: creating a local key corresponding to the local facial recognition results using the processor, the key including characteristics indicative of the local facial recognition results; receiving a user key from another network location using the communication device, the user key corresponding to the facial recognition results for the authorized user, but not including an image of a human face of the authorized user; and comparing the user key to the local key using the processor of the mobile device to produce a facial recognition comparison result.

In another embodiment, the method further comprises the steps of: performing an iris scan operation on the eye region of the human face detected in the FOV image from the memory to obtain a local iris scan result; comparing the local iris scan result with an iris scan result for an authorized user; determining an iris scan comparison result to be “successful” if the local iris scan result is within a predetermined criteria to the iris scan results for the authorized user; determining the iris scan comparison result to be “unsuccessful” if the local iris scan result is not within the predetermined criteria to the iris scan result for the authorized user; and recording the iris scan comparison result in the memory.

In yet another embodiment, the method further comprises: performing a plurality of real-time verifications of live person presence in sequence at the same network location during a set time period, recording the result of each of the plurality of real-time verification in the memory of the local device; recalling, following the set time period, the results of the plurality of real-time verifications; and determining, using the results of the plurality of real-time verifications, a single overall result of real-time live person presence at the network location for the set time period.

In a further embodiment, the overall result of real-time live person presence for the set time period is a qualitative value selected from one of two qualitative values.

In a still further embodiment, the overall result of real-time live person presence for the set time period is a quantitative value selected from within a range of quantitative values

### BRIEF DESCRIPTION OF THE DRAWINGS

For a more complete understanding, reference is now made to the following description taken in conjunction with the accompanying Drawings in which:

FIG. 1 is a functional diagram of a system and method for real-time live-person verification at a network location implemented using a mobile device in accordance with one aspect of the invention;

FIG. 2 is a close-up view of the eye of a human using the system of FIG. 1;

FIG. 3 is a functional diagram of a live-person verification system in accordance with another embodiment; and

FIG. 4 is a schematic diagram of a system for executing a method for real-time live person verification at a network location in accordance with another aspect.

### DETAILED DESCRIPTION

Referring now to the drawings, wherein like reference numbers are used herein to designate like elements throughout, the various views and embodiments of method and apparatus for real-time verification of live person presence on a network are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

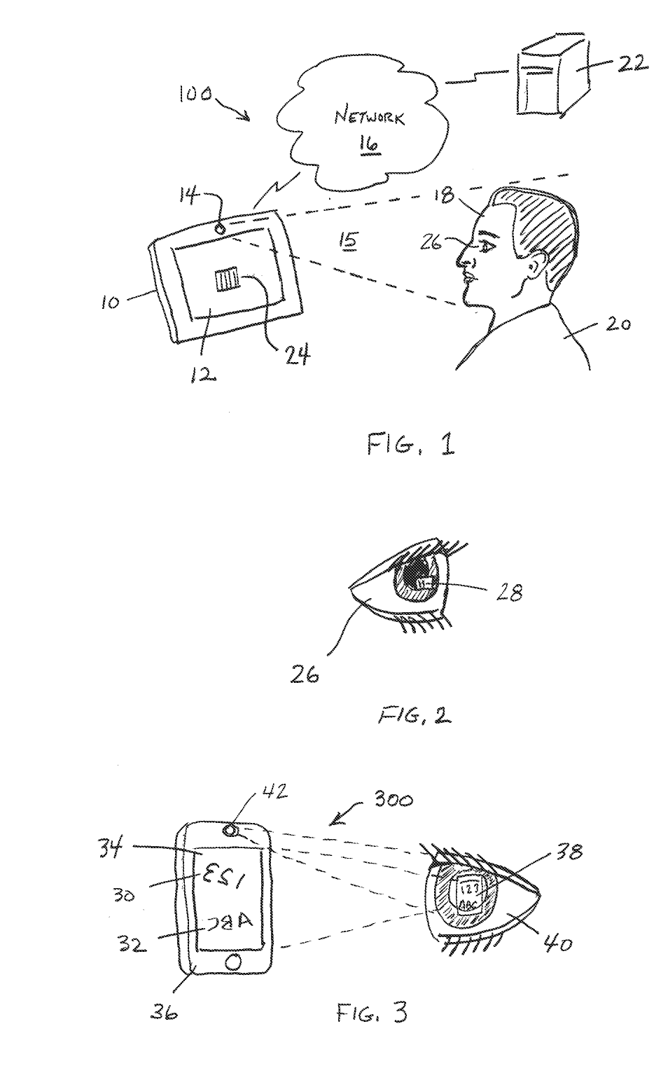

Referring now to FIG. 1, a system for real-time verification of live person presence on a network is implemented on a network in accordance with a first aspect of the invention. The system 100 includes a networked device 10 having a display screen 12 and a back-facing camera 14. The networked device 10 may be a personal computer (“PC”), smart phone, tablet computer or other mobile device having a display screen 12 and a back-facing camera 14. The network 16 to which the networked device 10 is connected may be any type of network including, but not limited to, the Internet, a WAN, a LAN, a VPN and/or a mobile network. The connections between the networked device 10 and the network 16 may be wired and/or wireless. A back-facing camera 14 is understood to be a camera having a field of view 15 (“FOV”) that includes the region facing the screen 12 of the device. Put another way, a back-facing camera 14 is any camera having a FOV 15 that can photograph the face 18 of a human user 20 viewing the device screen 12. The camera 14 may be built-in to the networked device 10 or it may be a separate camera (e.g., “web-cam”) positioned proximate to the device that can also communicate via the network 16. The system 100 may include a software application that is resident on the networked device 10 and/or resident at another location on the network, such as remote location 22. The system 100 may further include computer circuitry (not shown) for performing the software application. The computer circuitry may be located in the networked device 10 or at a remote location 22.

Referring still to FIG. 1, the system 100 generates a real-time security indicia 24 that is displayed on the screen 12 of the network device 10. The security indicia 24 may be a number, a character, a graphical rendering (e.g., a barcode, a 2D-barcode or 3D-barcode, a QR-code, a CAPTCHA code, etc.), a geometric shape, a specific color (e.g., the color of a displayed character/shape, or of a section of the screen 12, or of the entire screen), an image (e.g. a photo or drawing) and/or a sequence of individual indicia. The indicia 24 is preferably randomly generated or otherwise selected such that it is very difficult to predict what indicia will be used. If a human user 20 is facing the screen 12 when the security indicia 24 is displayed, the indicia is reflected in real-time off the eye 26 of the device user.

Referring now also to FIG. 2, a reflection 28 of the security indicia 24 will be formed in real-time on the eye 26 of the user 20 when the indicia appears on the screen 12. The back-facing camera 14 (see FIG. 1) can capture this reflection 28 and analyze it (e.g., using the system software and/or system computer circuitry) to determine if the reflected image is consistent with the real-time security indicia 24 that was being displayed at the time the capture took place. If necessary, the system 100 can enlarge the captured image and/or provide corrective transforms to correct for, e.g., the reversed image, the spherical nature of the eye, etc.

If the correct reflection 28 is detected, then the system 100 may treat this as validation that a live person is present in front of the networked device 10. On the other hand, if the correct reflection 28 is not detected, the system 100 may treat this as non-validation. Of course, the reflection test just described may be repeated as necessary for the desired level of security, preferably with a different real-time indicia 24 being displayed each time.

In additional embodiments, a verification system in accordance with this invention may utilize the reflected indicia test in combination with biometric tests including, but not limited to, facial recognition (e.g., photo and/or video capture from a stationary or mobile camera), and/or iris-scan and/or retina-scan.

In some embodiments of the system and method, the results of the real-time live person presence verification may be reported as a qualitative value, e.g., on a pass/fail basis, a yes/no basis, a successful/unsuccessful basis, etc. Stated another way, when the real-time live person presence verification result is reported as a qualitative value, the system either reports that a live person presence is detected at the network location, or the system reports that a live person presence is not detected at the network location.

In other embodiments of the system and method, the results of the real-time live person presence verification may be reported as a quantitative value, e.g., a numerical score selected from a range of possible scores. For example, a verification attempt may include presenting four discrete indicia 24 on the screen 12 at one time, and the range of possible verification result scores may range from “0” to “4”. If all four discrete indicia 24 of the verification attempt are detected by the camera 14, then the verification result score is reported as a score of “4”, whereas if only three of the four discrete indicia are detected, then the verification result score is reported as a score of “3”, etc. In another example, the real-time live person presence verification process cycle is run (i.e., attempted) successively ten times at the same network location within a set period. If the reflected security indicia 24 displayed in each respective verification attempt is detected by the camera 14 in all ten cycles during the set time period, then a quantitative verification score of “10” is reported; whereas if the reflected security indicia displayed in each respective verification attempt is detected by the camera in only three of the ten cycles, and not detected in the remaining seven cycles, then a quantitative score of “3” is reported. It will be appreciated that the previous examples are only a few of many possible quantitative score systems. In other examples, different ranges of possible verification result scores may be used, different numbers and/or types of indicia may be presented during a verification attempt, and/or the scores received for detecting different indicia may be weighted based on the different levels of confidence associated with detecting each type of indicia. Use of a quantified value for reporting the results of the real-time live person presence verification allows the verification result to correspond to a “confidence level” that a live person is present at the network location.

In still further aspects of the invention, the result of the real-time live person verification may be used as one component of a log-in procedure for granting access to a network resource from a network location.

In another aspect of the invention, a system and method for real-time verification of live person presence at a network location may operate according to the following steps:
1-A. The system receives a log-on request;
1-B. The system generates a first real-time security indicia;
1-C. The system displays at least the first real-time security indicia on the device screen;
1-D. The system back-facing camera captures first image of the FOV in front of the screen and transmits the first image to system;
1-E. The system analyzes the first image to identify any human face in the FOV; if no human face detected in FOV, log-on fails or displays error; otherwise process continues;
1-F. Optional: The system performs facial recognition of human face located in FOV and compares facial recognition results against authorized faces. If facial recognition does not detect authorized face, log-on fails or displays error; otherwise process continues;
1-G. The system identifies eye region of human face in FOV.
1-H. Optional: The system performs iris scan of eye region located in FOV and compares iris scan result against authorized iris images. If iris scan does not detect authorized iris, log-on fails or displays error; otherwise process continues;
1-I. The system analyzes image of eye region located in FOV to detect reflected (i.e., reverse) image of first security indicia. If appropriate reflected image of first security indicia not detected, log-on fails or displays error; otherwise process continues;
1-J. The system may generate and display additional real-time security indicia on screen, capture and transmit additional images of the FOV, and repeat the analysis/analyses described above as many times as desired;
1-K. If the received image(s) satisfy the security indicia reflection analysis (and optionally, the facial recognition and/or iris-scan analyses), then log-on is approved.

It will be appreciated that the order of many of the steps listed above, including the order of use of the optional biometric steps (e.g., facial recognition, iris scanning), may be changed without departing from the spirit and scope of the invention.

Referring now to FIG. 3, in another embodiment there are provided two separate real-time indicia, in this case CAPTCHA codes 30, 32, displayed backwards on the screen 34 of a networked device 36, in this case, a smartphone. For purposes of illustration, the two indicia 30, 32 are shown together on the screen 34, but it will be understood that the indicia may be displayed sequentially. Images of the indicia 30, 32 can be captured by a camera 42 via reflection 38 in the user's eye 40, either in a video capture sequence or two synchronized photo captures that are randomly generated and displayed. Anything that an individual 20 looks at is reflected off the eyes 40, so with the right light, optics and extraction algorithms, such randomly generated sequences of indicia 30, 32 could be captured to effectively prove a live person 20 is present for the purpose of facial recognition, and that the capture is being done real time, thereby mitigating any possibility of synthesizing an image such to defeat facial or iris recognition methods or techniques.

In yet another aspect of the invention, a system and method for real-time verification of live person presence at a network location may operate according to the following steps:
2-A. The system initiates a real-time live person verification at a network location. The verification may be associated with a network log-on request or an application log-on request, but is not required to be associated with such a log-on request.
2-B. The system generates a first real-time security indicia.
2-C. The system displays the first real-time security indicia on a device screen at the network location at a known time.
2-D. The system uses a back-facing camera at the network location to capture a first image of a field of view (“FOV”) in front of the device screen at the known time and transmits the first image to system.
2-E. The system analyzes the first image to detect any human face that was visible in the FOV at the known time. If no human face is detected in the first image, the real-time live person verification attempt is deemed unsuccessful; otherwise, the verification attempt continues.
2-F. Optionally, the system performs facial recognition of the human face detected in the FOV (the “local” results) and compares the local facial recognition results against the results for faces of one or more authorized users (e.g., stored in the memory or received from another network location). If the facial recognition comparison between the local result and the authorized faces is within predetermined criteria, the facial recognition operation is deemed successful. If the facial recognition comparison between the local result and the authorized faces is not within predetermined criteria, the facial recognition operation is deemed unsuccessful. In some cases, if the facial recognition operation does not detect an authorized face (i.e., is unsuccessful), the real-time live person verification attempt may be deemed unsuccessful and terminated, whereas in other cases, the unsuccessful facial recognition result is noted (e.g., recorded in the memory), but the real-time live person verification attempt continues. The facial recognition may be performed at the known time, or at a different time during the verification attempt.
2-G. The system identifies an eye region of the human face detected in the first image.
2-H. Optionally, the system performs an iris scan of the eye region detected in the FOV (the “local” result) and compares the result of the local iris scan against iris scan results for one or more authorized users (e.g., stored in the memory or received from another network location). If the iris scan comparison between the local result and the authorized users is within predetermined criteria, the iris scan operation is deemed successful. If the iris scan comparison between the local result and the authorized faces is not within predetermined criteria, the iris scan operation is deemed unsuccessful. In some cases, if the iris scan operation does not detect an authorized user (i.e., is unsuccessful), the real-time live person verification attempt may be deemed unsuccessful and terminated, whereas in other cases, the unsuccessful iris scan result is noted (e.g., recorded in the memory), but the real-time live person verification attempt continues. The iris scan recognition may be performed at the known time, or at a different time during the verification attempt.
2-I. The system analyzes the eye region detected in the first image to detect a reflected image of the first security indicia that was displayed at the known time. If the corresponding (i.e., reversed) reflected image of the first security indicia not detected, the real-time live person verification attempt is deemed unsuccessful; otherwise, the real-time live parson verification attempt is deemed successful.
2-J. The system records the result of the first real-time live person verification attempt.
2-K. The system may repeat some or all of the previous steps B through J to perform additional real-time live person verification attempts as many times as desired.
2-L. After performing the desired number of real-time live person verification attempts, the recorded results of the verification attempts are used to create a final (i.e., overall) verification result. The final verification result may be either a qualitative value or a quantitative value.
2-M. The system may provide the final verification result to another application on the network, or it may use the final verification result to make a local decision (e.g., sign-on authorization, etc.).

It will be appreciated that the order of many of the steps listed above, including the order of use of the optional biometric steps (e.g., facial recognition, iris scanning), may be changed without departing from the spirit and scope of the invention.

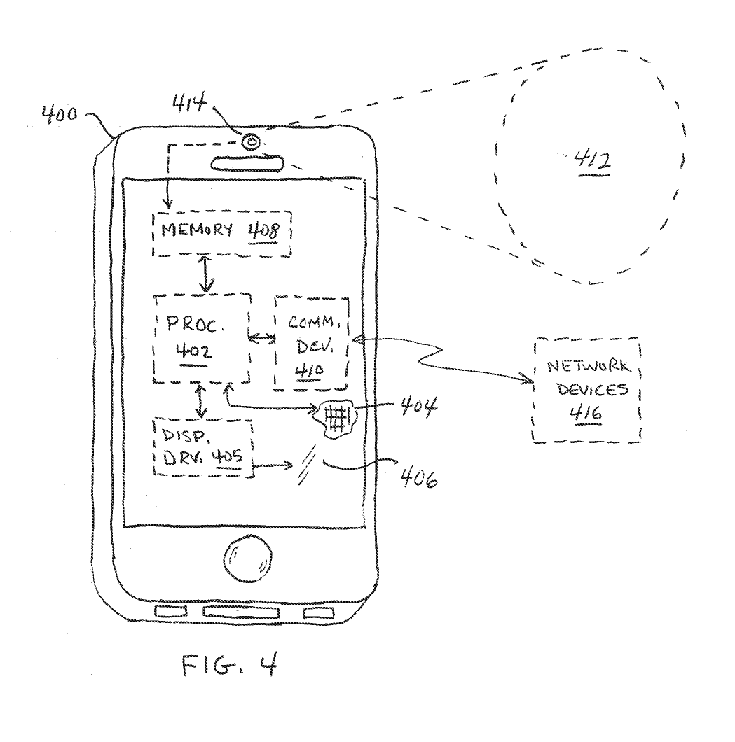

Referring now to FIG. 4, there is illustrated a system for executing a method for real-time verification of live person presence at a network location in accordance with a further aspect of the invention. The system is typically executed using a mobile device 400. The mobile device 400 may be a smart phone such as an iPhone™ brand smart phone running the iOS™ brand operating system, a smart phone running the Android™ brand operating system, a smart phone running the Windows™ brand operating system, another smart phone, a tablet such as the iPad™ brand tablet running the iOS™ brand operating system, a tablet running the Android™ brand operating system, a tablet running the Windows™ brand operating system or another tablet.

The mobile device 400 includes a processor 402 and a display screen 406 operatively coupled to the processor, e.g., via display driver 405. In the illustrated embodiment, the mobile device 400 includes a touch screen device 404 (only a portion of the touch screen is illustrated in FIG. 4) operatively coupled to the processor; however, a touch screen device is not required. The mobile device 400 further includes a memory 408 operatively coupled to the processor, a communication device 410 operatively coupled to the processor, and a back-facing digital camera 414 operatively coupled to the processor. The back-facing digital camera 414 has a field of view (“FOV”) 412 such that the camera can photograph the face of a human user as the human user is viewing the display screen 406. Digital photographs or images of human faces or other objects within the FOV of the camera 414 taken by the camera may be stored in the memory 408 by the processor 402. One or more security indicia 24 (see FIG. 1) may be stored in the memory 408. The security indicia 24 may be generated on the mobile device 400 itself, and/or they may be generated at another network location 416 and transmitted to the mobile device via the communication device 410. The communication device 410 may be a wired communication device (e.g., wired Ethernet card, etc.) or a wireless communication device (e.g., cellular radio device, Wi-Fi device, Bluetooth device, etc.).

The method for real-time verification of live person presence at a network location that may be executed on the system including mobile device 400 includes the following steps: Initiating a real-time live person verification at the mobile device 400 (in this case, the network location is the location of the mobile device). The verification may be associated with a network log-on request or an application log-on request made by the user of the mobile device 400, but is not required to be associated with such a log-on request. The system then begins first verification attempt by providing a real-time security indicia 24 (see FIG. 1). The real-time security indicia 24 may be generated by the processor 402, retrieved from the memory 408, or received via the communication device 410 from another network location. The system then displays the real-time security indicia 24 on the display screen 406 of the mobile device 400 at a known time using the processor 402. The system then uses the back-facing camera 414 on the mobile device 400 to capture an image (i.e., “the FOV image”) of everything within the FOV 412 in front of the device screen 406 at the known time, and the processor 402 records the FOV image in the memory 408.

The system analyzes the FOV image from the back facing camera 414 to identify any human face detectable in the FOV 412 at the known time. Preferably, the human face detection operation is performed in the mobile device, e.g., using the processor 402. If no human face is detected in the FOV image, the real-time live person verification attempt is deemed unsuccessful; otherwise, the verification attempt continues. In some embodiments, the system performs facial recognition of the human face detected in the FOV 412, and compares facial recognition results against authorized faces. Images of authorized faces and/or encrypted keys corresponding to authorized faces may be retrieved from the memory 408 or received from another network location via the communication device 410. Preferably, the facial detection operation is performed in the mobile device 400 itself, e.g., using the processor 402 and without sending the FOV image to another network location. In some cases, if the facial recognition operation does not detect an authorized face, the real-time live person verification attempt may be deemed unsuccessful and terminated, whereas in other cases, the unsuccessful facial recognition result is noted, but the real-time live person verification attempt continues. The facial recognition operation may be performed at the known time, or at a different time during the verification attempt.

The system identifies an eye region of the human face detected in the FOV image from the FOV 412. In some embodiments, the system performs iris scanning of the eye region detected in the FOV 412 (i.e., the “local” scan result), and compares the local iris scanning results against iris scans of one or more authorized users using the processor 402. Iris scans of authorized users and/or encrypted keys corresponding to authorized iris scans may be retrieved from the memory 408 or received from another network location via the communication device 410. Preferably, the iris scanning and comparison operation is performed in the mobile device 400 itself, e.g., using the processor 402 and without sending the iris scan from the FOV image to another network location. In some cases, if the iris scanning and comparison operation does not detect the iris of an authorized user, the real-time live person verification attempt may be deemed unsuccessful and terminated, whereas in other cases, the unsuccessful iris scanning comparison is noted, but the real-time live person verification attempt continues. The iris scan recognition may be performed at the known time, or at a different time during the verification attempt.

The system analyzes, using the processor 402, the eye region detected in the FOV image to detect a reflected image of the security indicia 24 that was displayed at the known time. If the corresponding (i.e., reversed) reflected image of the security indicia 24 is not detected, the real-time live person verification attempt is deemed unsuccessful. If the corresponding image of the security indicia is detected, the real-time live parson verification attempt is deemed successful. The system may record the result of each real-time live person verification attempt in the memory 408.

After each real-time live person verification attempt is completed, the system may repeat some or all of the previous steps to perform as many additional real-time live person verification attempts as desired. In some cases, a predetermined number of real-time live person verification attempts will be made, whereas in other cases, the number of real-time live person verification attempts to be performed will be dependent on a parameter received by the mobile device 400 via the communication device 410. For example, different network applications may request different numbers of real-time live person verification attempts depending upon the level of security desired.

After performing the desired number of real-time live person verification attempts, the recorded results of the verification attempts are retrieved by the processor 402 from the memory 408 and used to create a final verification result. The final verification result may be a pass/fail outcome or a quantitative value. The mobile device 400 may provide the final verification result via the communication device 410 to another application on the network, or the mobile device may use the final verification result to make a local decision (e.g., sign-on authorization, etc.).

It will be appreciated that the order of many of the steps executed on the system described above, including the order of use of the optional biometric steps (e.g., facial recognition, iris scanning), may be changed without departing from the spirit and scope of the invention.

It will be further appreciated by those skilled in the art having the benefit of this disclosure that this method and apparatus for real-time verification of live person presence on a network provides enhanced security for network users. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for real-time verification of live person presence on a network, the method executable on a networked computer system, the method comprising the following steps:
the system receives a verification request;
the system generates a first real-time security indicia;
the system displays at least the first real-time security indicia on a device screen;
the system uses a back-facing camera to capture a first image of a FOV in front of the device screen;
the system analyzes the first image to identify a human face in the FOV;
the system identifies an eye region of the human face;
the system analyzes the image of the eye region to detect a reflected image of the first security indicia;
if the reflected image of the first security indicia is not detected, then the verification fails; and
if the reflected image of the first security indicia is detected, then the verification continues.

2. A method in accordance with claim 1, further comprising the following steps:
the system performs a facial recognition of a human face located in the FOV and compares the facial recognition result for the human face against a facial recognition result for an authorized face; and
if the facial recognition comparison does not match the authorized face, the verification fails, otherwise the verification continues.

3. A method in accordance with claim 1, further comprising the following steps:
the system performs an iris scan of the eye region located in the FOV and compares an iris scan result for the eye region against an iris scan result for an authorized user; and
if the iris scan comparison does not match the authorized user, then the verification fails, otherwise the verification continues.

4. A system for real-time verification of live person presence at a network location, the system comprising:
a networked device operatively connected to a network and having a display screen;
a back-facing camera operatively connected to the networked device, the camera having a field of view (“FOV”);
a security indicia displayed on the screen of the network device for a discrete period of time;
a photo image of the FOV taken by the back-facing camera during the discrete time period when the security indicia was displayed on the screen;
computer circuitry on the networked device executing software to evaluate the photo image of the FOV to detect if a reflected image of the security indicia is present in the photo image of the FOV, and
if a human face is present in the photo image of the FOV;
wherein, if the computer circuitry detects both the reflected image of the security indicia and the human face in the photo image, a positive result of live person presence at the network location is stored in a memory; and
wherein, if the computer circuitry fails to detect either the reflected image of the security indicia or the human face in the photo image, a negative result of live person presence at the network location is stored in the memory.

5. A system in accordance with claim 4, wherein:
the system performs a plurality of real-time verifications of live person presence in sequence at the same network location during a set time period, recording the result of each of the plurality of real-time verifications in the memory;
following the set time period, the system recalls the results of the plurality of real-time verifications; and
using the results of the plurality of real-time verifications, the system determines a single overall result of real-time live person presence for the set time period.

6. A system in accordance with claim 5, wherein the overall result of real-time live person presence for the set time period is a qualitative value selected from one of two qualitative values.

7. A system in accordance with claim 5, wherein the overall result of real-time live person presence for the set time period is a quantitative value selected from within a range of quantitative values.

8. A method for execution on a mobile device for real-time verification of live person presence at a network location, the mobile device having a processor, a display screen operatively coupled to the processor, a memory operatively coupled to the processor, a communication device operatively coupled to the processor and a back-facing digital camera operatively coupled to the processor and having a field of view (“FOV”) such that the camera can photograph a face of a human user when the human user is viewing the display screen, the method comprising the following steps:
producing, using the processor of a mobile device at a network location, a real-time security indicia on the mobile device;
displaying, on a display screen of the mobile device that is operatively connected to the processor, the real-time security indicia at a known time at the network location;
capturing, using a back-facing digital camera that is operatively connected to the processor and has a FOV such that the camera can photograph a face of a human user when the human user is viewing the display screen, an FOV image of the objects within the FOV in front of the display screen at the known time;
storing the FOV image in a memory of the mobile device that is operatively connected to the processor;
detecting, using the processor, any human face present in the FOV image stored in the memory;
detecting, using the processor, an eye region of the human face present in the FOV image stored in the memory;
detecting, using the processor, whether a reflected image of the security indicia is present in the eye region of the human face in the FOV image stored in the memory;
determining the result of the live person verification to be “successful” if a reflected image of the real-time security indicia is detected in the eye region of the human face in the FOV image stored in the memory;
determining the result of the live person verification to be “unsuccessful” if a reflected image of the security indicia is not detected in the eye region of the human face in the FOV image stored in the memory; and
storing the result of the live person verification in the memory of the mobile device.

9. A method in accordance with claim 8, further comprising the steps of
performing a facial recognition operation on the human face detected in the FOV image from the memory to obtain a local facial recognition result;
comparing the local facial recognition result with a facial recognition result for an authorized user;
determining a facial recognition comparison result to be “successful” if the local facial recognition result is within a predetermined criteria to the facial recognition results for the authorized user;
determining the facial recognition comparison result to be “unsuccessful” if the local facial recognition result is not within the predetermined criteria to the facial recognition comparison result for the authorized user; and
recording the facial recognition comparison result in the memory.

10. A method in accordance with claim 9, wherein the facial recognition operation includes:
creating a local key corresponding to the local facial recognition result using the processor, the local key including characteristics indicative of the local facial recognition result, but not including an image of the human face from the FOV image;
transmitting the local key to another network location using the communication device;
comparing the local key to a user key corresponding to the facial recognition result for the authorized user at another network location; and
receiving a facial recognition comparison result from another network location using the communication device.

11. A method in accordance with claim 9, wherein the facial recognition operation includes:
creating a local key corresponding to the local facial recognition result using the processor, the local key including characteristics indicative of the local facial recognition result;
receiving a user key from another network location using the communication device, the user key corresponding to the facial recognition result for the authorized user, but not including an image of a human face of the authorized user; and
comparing the user key to the local key using the processor of the mobile device to produce a facial recognition comparison result.

12. A method in accordance with claim 8, further comprising the steps of
performing an iris scan operation on the eye region of the human face detected in the FOV image from the memory to obtain a local iris scan result;
comparing the local iris scan result with an iris scan result for an authorized user;
determining an iris scan comparison result to be “successful” if the local iris scan result is within a predetermined criteria to the iris scan results for the authorized user;
determining the iris scan comparison result to be “unsuccessful” if the local iris scan result is not within the predetermined criteria to the iris scan result for the authorized user; and
recording the iris scan comparison result in the memory.

13. A method in accordance with claim 8, further comprising the following steps:
performing a plurality of real-time verifications of live person presence in sequence at the same network location during a set time period, recording the result of each of the plurality of real-time verification in the memory of the local device;
recalling, following the set time period, the results of the plurality of real-time verifications; and
determining, using the results of the plurality of real-time verifications, a single overall result of real-time live person presence at the network location for the set time period.

14. A method in accordance with claim 13, wherein the overall result of real-time live person presence for the set time period is a qualitative value selected from one of two qualitative values.

15. A system in accordance with claim 13, wherein the overall result of real-time live person presence for the set time period is a quantitative value selected from within a range of quantitative values.
